(19) United States
(12) Patent Application Publication
(10) Pub. No.: US 2011/0032141 A1
(43) Pub. Date: Feb. 10, 2011

(54) Modular Radar Architecture

(75) Inventor: Philippe Elleaume, Verrieres le Buisson (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, Neuilly-sur-Seine (FR)

(21) Appl. No.: 12/671,879

(22) PCT Filed: Jul. 31, 2008
(86) PCT No.: PCT/EP08/60068

§ 371 Date: Mar. 25, 2010

(30) Foreign Application Priority Data
Aug. 3, 2007 (FR) 07 05709

(51) Int. Cl. G01S 7/03

(52) U.S. Cl. 342/197

(57) ABSTRACT

The present invention relates to the field active electronic scanning radar systems. It provides an architecture for active antenna radar based on a functional unit, the elementary radar unit. The elementary radar unit comprises all of the functions required for generating N independent radar channels. In this regard, it comprises a radiating face with N radiating elements and means for independently generating the radar waves emitted by each of the radiating elements and all of the functions for receiving the waves picked up by this radiating element, together with the digitization of the video signal obtained after reception. It also comprises local digital processing means allowing the digital signals coming from the N channels to be jointly processed. The association of M elementary radar units with a general synchronization module and a global digital processing module advantageously allows a truly modular radar system to be formed, whose configuration can be modified, notably according to the revision of the functions assigned to the radar in question.

The present invention relates to radar architectures. It relates more particularly to the architecture of electronic scanning radar systems, comprising an antenna capable of exploring a region of space in bearing and in elevation by electronic scanning of one or more digitally controlled beams.

Both in the field of GROUND/AIR radar detection and in that of SEA/AIR detection, the current operational demands are driving the development of multi-mission radar systems. Multi-mission radar is generally understood to mean radar systems capable of performing several types of functions during the same phase of operation (surveillance, detection, tracking), where the function performed may be different depending on the portion of space in question. It also relates to radar systems capable of performing at different times, on command, different missions or of assuming different roles within a more extensive surveillance structure. Using a multi-mission radar allows both the number of radar units required for operational needs to be reduced, and the operational performance of the systems implemented to be enhanced.

The notion of multi-mission radar is furthermore, in a known manner, intimately linked to the notion of electronic scanning, a functionality which may be implemented both in the case of a rotating antenna and of a fixed antenna. In both cases, the need for flexibility in the management of space and time, which characterizes multi-mission radar systems, requires, as a minimum, means for performing electronic scanning in two planes, a horizontal plane (bearing or azimuth scanning) and a vertical plane (elevation scanning). For certain particular applications, the search for the multi-mission character leads to developing radar equipment having the capacity for simultaneously forming several observation beams aimed in different spatial directions and generally designed for the execution of different tasks. Thus, with the same equipment, aerial surveillance, terrestrial surveillance, target tracking and/or projectile or aircraft guidance missions may be carried out. Moreover, this approach can now be envisioned thanks to the technological progress made if the field of “solid state” microwave transmission, in other words transmission from semiconductor transmission modules. Miniaturization of such components together with the significant improvement in power efficiencies now truly make possible the implementation of active antennas composed of radiating elements distributed over a given area, each radiating element being powered by a separate active module such that the radar equipment has one transmitter per spatially independent source. The observation beam or beams are then subsequently formed by spatial combination of the elementary beams formed by all or some of the sources forming the overall antenna. Such a technology is currently quite feasible, both from a technical and from a cost perspective, for the production of electronic scanning antennas, in particular for equipment operating in the centimeter bands (L, S, C and X). Accordingly, the design of a multi-mission centimeter-band radar naturally includes the implementation of an active electronic scanning antenna in 2 planes.

Although technological progress makes the design of multi-mission radar equipment affordable, this equipment nevertheless remains relatively more costly, notably at the design stage, than more conventional radar equipment, such as radar systems with conventional rotating antennas for which the electronic scanning for example takes place in a single plane, the vertical plane (elevation scanning), scanning in the horizontal plane (azimuth scanning) being carried out by rotation of the antenna. This cost differential is furthermore made more sensitive due to the fact that, at the present time, the design of a multi-mission radar includes an original definition step specifically adapted to the operational roles allocated to the radar in question, no structure being proposed that allows various models of multi-mission radar to be developed on the same conceptual basis. In particular, the definition of a new radar system generally includes the definition of a new antenna specifically adapted to the requirements, and also that of the interconnection of this antenna with the various sub-assemblies responsible notably for the synthesis of the transmitted signal and for the demodulation of the signal picked up by this antenna.

One objective of the invention is to provide a means allowing the design of multi-mission radar systems to be simplified based on the implementation of active electronic scanning antennas. Another aim is to enable the construction of radar systems whose operational capacities may be modified, without physical modification. Yet another aim is to enable upgradable radar systems to be constructed that can incorporate new functions not included in the initial definition and whose various functions can be updated without it being necessary to modify from a component point of view the sub-assemblies and/or the interfaces between the various sub-assemblies.

For this purpose, the subject of the invention is a modular radar architecture characterized in that it comprises a plurality of identical elementary radar units connected in parallel, each unit itself comprising:

a standard radiating surface comprising N radiating elements, capable of emitting and of picking up microwave radiation,

microwave emission and detection means for generating and transmitting to the radiating elements a microwave signal of a given form and power and also for amplifying the microwaves picked up by the radiating elements,

receiver means for performing the transposition into video band of the microwaves picked up and the digitization of the video signals obtained,

digital processing means for carrying out the conditioning of the digital signals supplied by the receiver means;

microwave signal generation means associated with a digitally-controlled waveform generator;

the microwave generation means, transmission means and receiver means each being composed of N independent devices configured for forming, with the N radiating elements, N independent channels, the processing means and the synchronization means being common to all of the channels.

In one preferred embodiment, the architecture according to the invention also comprises:

a plurality of elementary radar units according to the invention

a sub-assembly responsible for the general synchronization of the structure, supplying to each sub-assembly a set of identical reference signals,

a global digital processing sub-assembly responsible for carrying out the processing of the conditioned signals supplied by each of the elementary radar units,

the various sub-assemblies being connected together by an appropriate data and signal exchange structure.

The features and advantages of the invention will be better appreciated thanks to the description that follows, which description notably presents the invention by way of particular applications taken as non-limiting examples and which rely on the appended figures, which show:

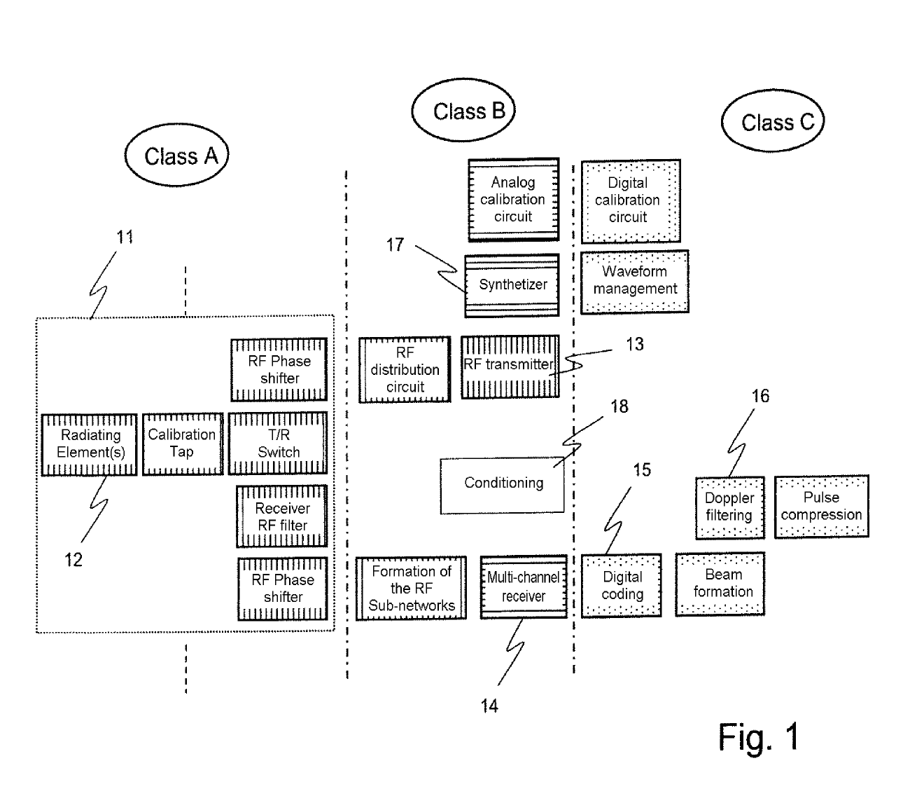

FIG. 1, a block diagram indicating the breakdown into operational sectors of a conventional passive antenna electronic scanning radar system,

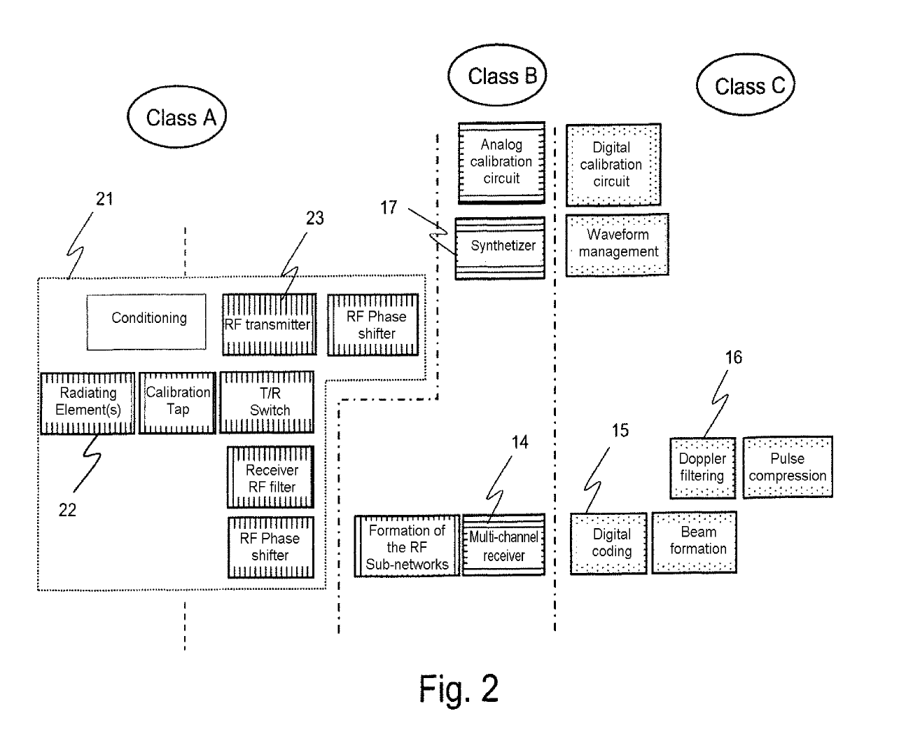

FIG. 2, a block diagram indicating the breakdown into operational sectors of a conventional active antenna radar system,

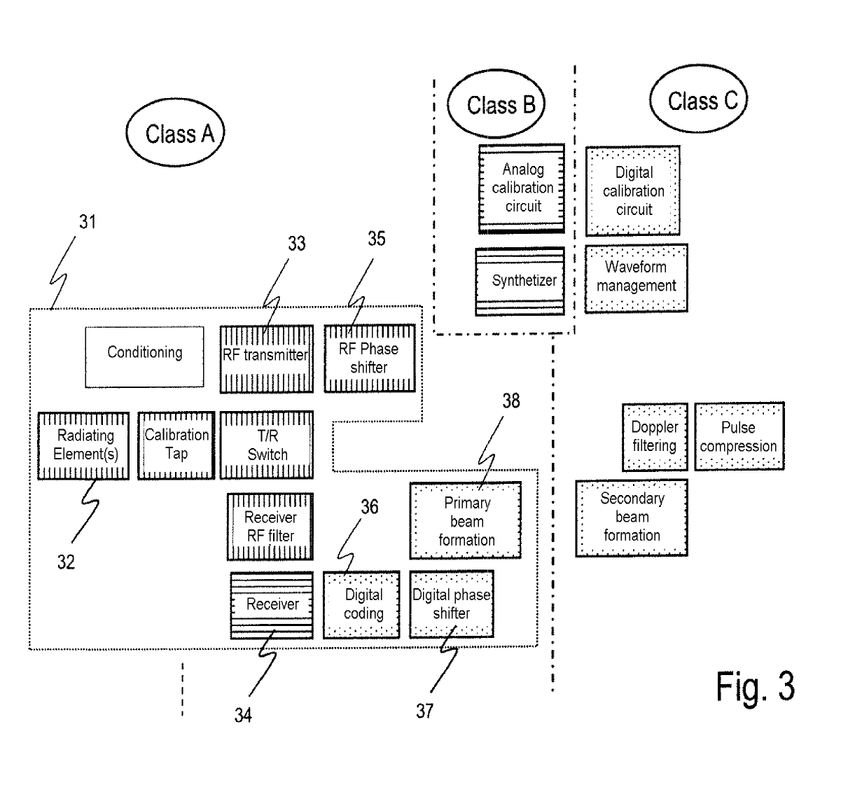

FIG. 3, a block diagram indicating the breakdown into operational sectors of a radar system defined based on the architecture according to the invention,

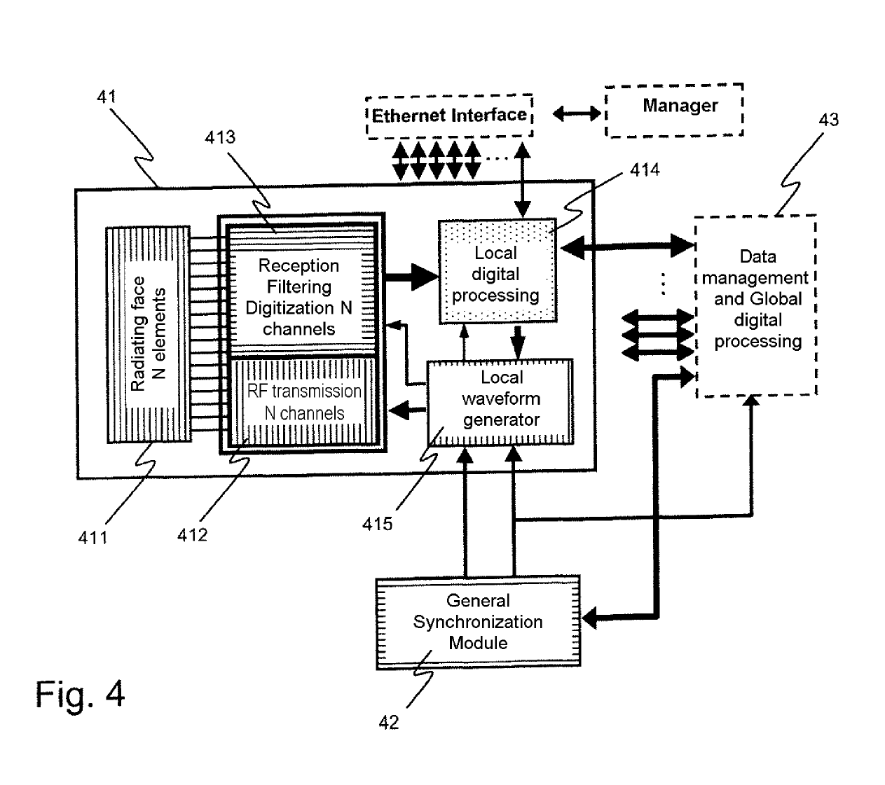

FIG. 4, a schematic diagram representing the various types of sub-assemblies making up the architecture according to the invention,

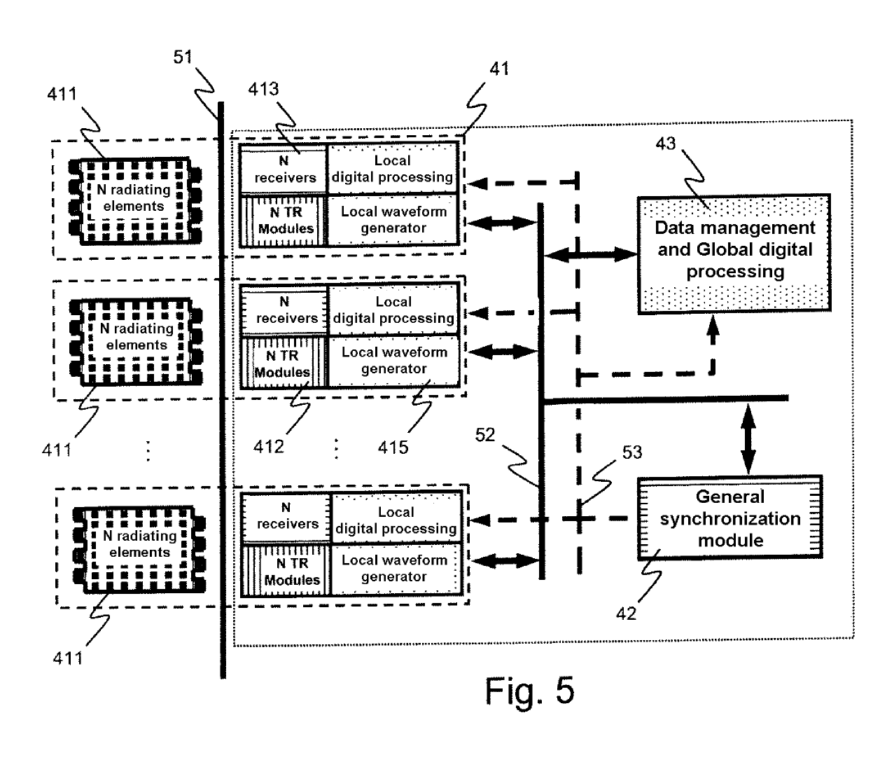

FIG. 5, a schematic diagram showing the structure of a radar device designed based on the architecture according to the invention;

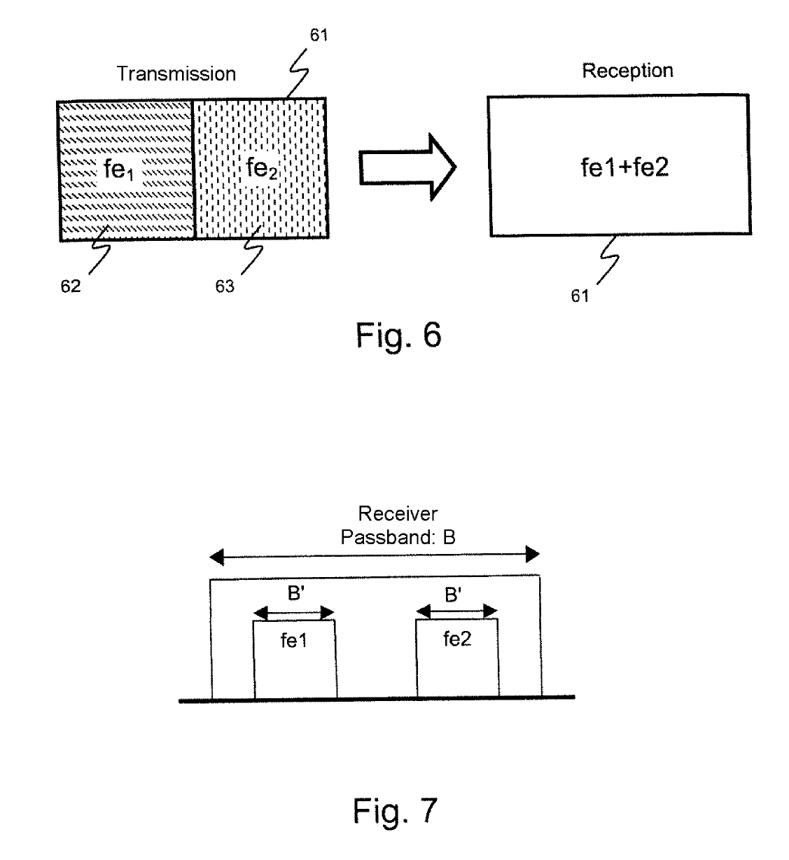

FIGS. 6 and 7, illustrations relating to a first exemplary embodiment of the architecture according to the invention,

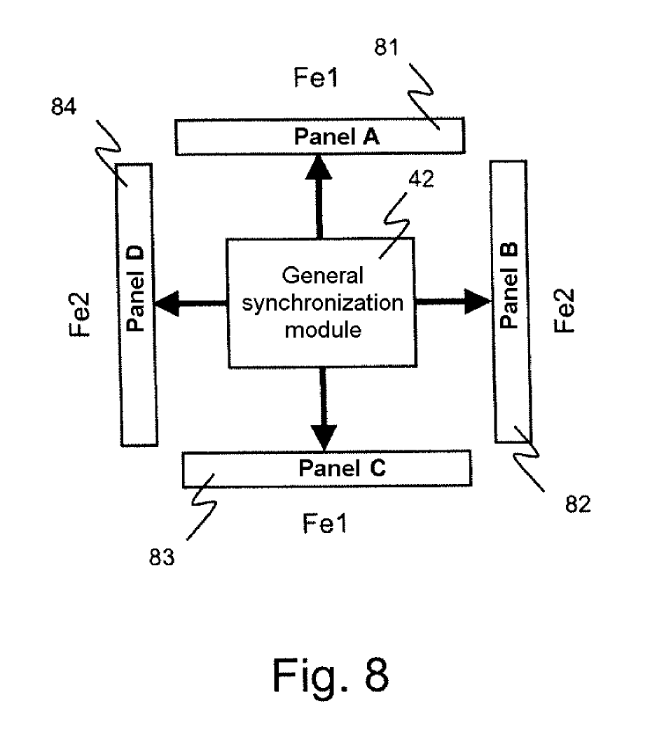

FIG. 8, an illustration relating to a second exemplary embodiment of the architecture according to the invention,

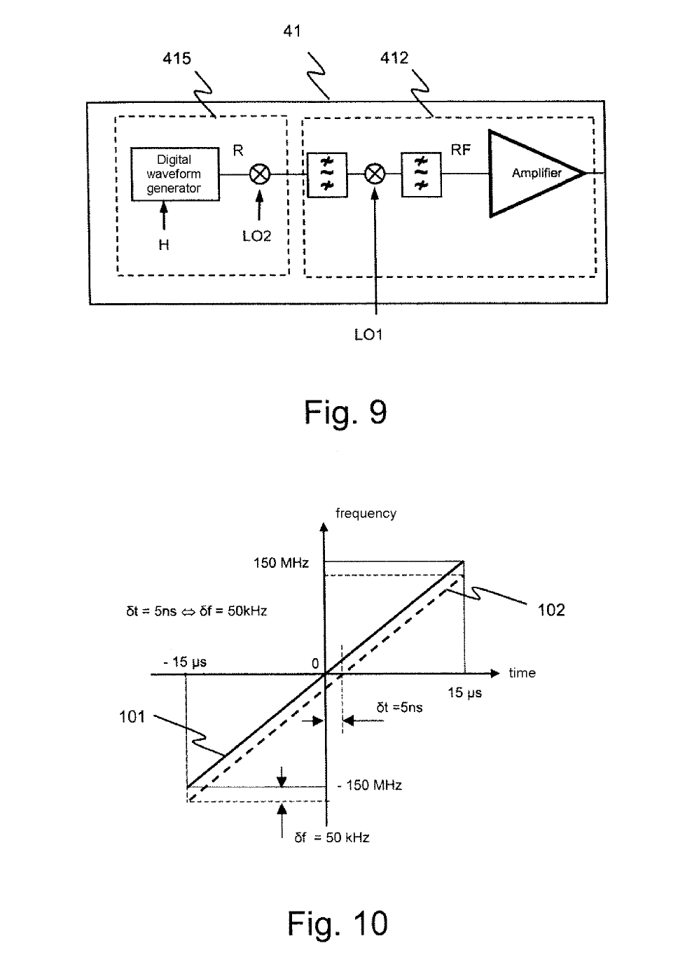

FIGS. 9 and 10, illustrations relating to a third exemplary embodiment of the architecture according to the invention.

First of all, FIG. 1 will be considered.

As was previously stated, one of the challenges currently facing designers of radar systems consists in finding means for designing architectures capable of being subject to both functional and technological upgrading at the lowest possible cost. These upgrades consist for example in replacing existing sub-assemblies by sub-assemblies providing similar functions but with an enhanced performance or else by sub-assemblies performing identical functions but whose cost of fabrication and/or dimensions are reduced. These upgrades may include the addition of further functions not present in the original equipment. In any case, frequently, owing to their degree of sophistication, the upgrading of these radar systems generally includes, amongst other things, significant modifications of the essential elements of infrastructure composing the interfaces. A consequence of this is that a radar system can generally not easily be upgraded, any modification of the technology, of the functionalities or of the performance resulting in a more or less significant restructuring of the system. The illustration in FIG. 1 allows the causes of this situation to be clearly evaluated in the context of a passive electronic scanning radar.

The general structure of this type of radar, well known to those skilled in the art, is not detailed here. It is simply observed here that it is possible to categorize the sub-assemblies composing such a radar system into three structural classes:

Class A, grouping the functional sub-assemblies that may naturally be coupled in parallel and are present in large numbers within each radar;

Class C, grouping functional sub-assemblies integrated into a common structure;

Class B, functional sub-assemblies that cannot be categorized in either class A or class C.

Class A comprises, in particular, the sub-assemblies allowing electromagnetic waves to be radiated or to be picked up. In the case of an electronic scanning radar equipped with a passive antenna, these are for example sub-assemblies 11 comprising all of the elements allowing a radiating element 12, or a set of radiating elements forming a radiating source, forming the antenna, to radiate the electromagnetic wave generated by the transmitter 13, together with those allowing the electromagnetic waves picked up by the radiating element 12 to be transmitted to the receiver 14. Such a sub-assembly 11 is considered as naturally able to be coupled in parallel in the sense that its integration into the system is carried out by connecting it to the input/outputs of the system provided for this purpose. The addition or elimination of a module of this type in order to modify the overall operation of the system does not affect the intrinsic operation of the other sub-assemblies of the same type.

Class C is principally composed of the digital functional sub-assemblies, carrying out functions for processing the received signals after digitization or for processing and management of digital data, these functions being implemented by digital “multi-node” processing machines capable of carrying out various operations, known to those skilled in the art, such as pulse compression, Doppler filtering 16, waveform control, etc. “Node” (i.e. “processing node”) is taken here to mean a processor, single or multicore, with its external memory (SRAM and/or DRAM) and its communication links with the internode communications network or networks allowing the various nodes of the machine to exchange information. The number and the size of the machines implemented essentially depend on the number and type of functions carried out and also on the computing capacity of these machines. The addition or the elimination of such functional sub-assemblies is therefore carried out by enabling or disabling computing sub-routines and/or addition of processing nodes. This operation does not generally affect the architecture integrating the machines used, as long as the latter offers the required flexibility.

With regard to class B, for currently developed radar systems, this forms the part of the system offering the least leeway to undergo upgrading without requiring significant reorganization. Class B machines are moreover machines that fulfill more specific functions for each design of radar system. In particular, these include all the analog functional sub-assemblies such as the synthesizers 17 whose function generally consists in delivering synchronization and timing signals to the other sub-assemblies, which signals are generally specific to the sub-assembly for which they are intended. The transmitter 13 and receiver 14 sub-assemblies are also included here as is the sub-assembly 18 responsible for the air conditioning of the system.

Such a radar system, comprising a large number of class B functional sub-assemblies, is therefore, by nature, not readily upgradable so that, for example, two radar systems having different functional characteristics cannot be designed based on the same hardware structure, even if they have identical basic functionalities. Their design makes use of different hardware equipment (transmitter, receiver, synchronization signal generation module, or even the interconnection structure for example) customized for and specific to each system and hence non-interchangeable.

FIG. 2 is next considered which shows the distribution, within the three structural classes defined previously, of the various sub-assemblies composing an electronic scanning radar with active antenna such as may be currently developed.

As the figure illustrates, such radar systems are generally designed as a simple adaptation of the architectures developed for passive antenna electronic scanning radar systems. The proportion of sub-assemblies belonging to class B therefore remains high, as the figure illustrates. In fact, in order to develop an active antenna electronic scanning radar system, it is generally sufficient to modify the transmission chain by replacing the single transmitter 13 (for example an electronic power tube), and the circuit 19 for distributing the microwaves to the radiating elements 22, by semiconductor transmission circuits 23 (solid sate emitters) localized within each radiating source 21. However, as far as the rest of the architecture is concerned, nothing is modified.

This type of approach has the immediate advantage of limiting the technological risks run when designing an active antenna radar. As long as the structure used remains very close to that of a passive antenna radar, the development costs are furthermore limited to the part of the development required to integrate new radiating sources each comprising an emission module.

This approach naturally increases the number of sub-assemblies belonging to Class A, the class of modules able to be naturally connected in parallel, by integrating into it the modules participating in the transmission. The transmitted power thus becomes a modifiable characteristic, since it is a function proportional to the number of transmission channels implemented.

In contrast, such an approach does not, in itself, allow the mounting of receiver functions in parallel to be envisioned.

FIG. 3 will next be considered, which presents the architecture concept according to the invention. As the figure illustrates, the architecture principle proposed notably consists in integrating into each of the radiating sources 31, not only the elements necessary for generating a transmission signal (transmitter circuit 33, phase shifter circuit 35), but also the elements needed to carry out the demodulation of the signals picked up (receiver circuit 34), together with the elements 36, 37 and 38 for digitizing the received signals and for carrying out digitally the conditioning operations on these signals. Accordingly, each sub-assembly 31 forms a stand-alone assembly that incorporates all of the means enabling the emission and the sensing of microwave radiation, but also the means for generating, demodulating and conditioning these waves. Consequently, the elements of classes A and C become preponderant in the radar architecture, whereas the elements of class B are strictly limited in number, and can be made generic for a given Radar Band. A radar structure is thus obtained that is advantageously formed from an association of independent sub-assemblies that may be separately configured and arranged so as to perform the desired operational functions.

FIG. 4 is now considered, which presents a schematic diagram showing the various types of sub-assemblies defining a radar architecture according to the invention. The architecture is partially presented here emphasizing the sub-assemblies responsible for providing the functions relating to the transmission, to the reception, to the local generation of the main synchronization signals, to the synthesis of the transmitted waveform and to the processing of the radar signal, which are all objects of the invention claimed here. The sub-assemblies situated downstream of these sub-assemblies, which are in particular responsible for processing the data generated from the received signals (overall management of the system, extraction, tracking, mission computing, etc.), are not shown here for reasons of clarity.

The radar architecture according to the invention principally comprises:

a first type 41 of sub-assembly, or Building-Block, consisting of an elementary radar unit, or mini-radar;

a second type 42 of sub-assembly, consisting of a signal generator intended for general synchronization,

a third type 43 of sub-assembly, consisting of one or more parallel signal processing machines (computers).

The first type of sub-assembly 41, an elementary radar unit, principally comprises:

a radiating face 411 comprising N radiating elements mounted on a supporting structure (substrate),

N microwave circuits 412, or TR modules, each comprising a solid state transmitter device associated with a microwave phase shifter, together with a microwave receiver head itself comprising a low-noise amplifier and limiter device,

N receiver modules 413 also comprising a digitization circuit for the video signal,

a local digital processing module 414 for the received signals, after digitization. This device notably allows the received signals to be conditioned by the various elements of the radiating face. Amongst other operations, conditioning is understood to mean the combination with the desired amplitudes and phases, after digitization, of the signals picked up by the radiating elements forming the radiating face, this combination allowing one or more primary reception beams to be formed in the desired direction(s).

a module 415, local waveform and synchronization generator, whose role is to synthesize all of the synchronization signals and analog reference signals from the common signals generated by the single sub-assembly 42.

This first sub-assembly 41 thus, by itself, comprises the whole of the resources needed for transmitting and receiving a microwave signal over N channels. It also comprises the resources for processing the microwaves received over all of the N channels and, amongst other operations, for combining the various channels together to form various beams that may be aimed in various directions. This is the reason for it being defined here as an independent elementary radar unit with active electronic scanning, or mini-radar.

Advantageously, integrating directly into this mini-radar a non-dedicated parallel machine considerably enhances the genericity of the mini-radar. This original structure constitutes an essential feature of the structure according to the invention.

The second type of sub-assembly 42, a general synchronization module, comprises all of the means allowing several sub-assemblies 41 to be operated in a coordinated manner, in other words to associate in their operation several elementary radar units so as to form a larger radar system. For this purpose, it comprises means for, on the one hand, generating high-level synchronization signals and, on the other, for synthesizing one or more local reference oscillators. According to the invention, these generic reference signals are advantageously identical for all the sub-assemblies to which they are supplied. With regard to the particular synchronization signals, required for the individual operation of each of the elementary units 41, these are generated locally within the units using the synchronization signals supplied by the sub-assembly 42.

According to the invention, the general synchronization signals are distributed to the various sub-assemblies via point-to-point links 421 (electrical, optical, etc.).

The third type of sub-assembly 43, a data management and global digital processing module, comprises one or more parallel digital machines (computers), arranged so as to be able to carry out all of the digital processing operations on the signals delivered by the elementary radar units 41, and also so as to be able to generate and deliver to these same elementary radar units the information and the commands needed by each unit to determine its individual mode of operation.

In one preferred mode of operation, the local digital processing devices 414, localized within the elementary radar units 41, and the module 43 cooperate according to the following general principle:

Each local digital processing module 414 principally carries out the processing and the association of the digital data corresponding to the N receiving channels included in the elementary radar unit to which they belong. The purpose of this association is to combine the digital data from the various receiving channels in order to form a given number M of beams aimed in various directions of space; the digital formation of beams is based on techniques known to those skilled in the art so is not developed here. However, incidentally, the bit-rate of the data produced at the processing output is reduced.

This data is subsequently transmitted by each module 414 to the global processing module 43 which recombines the data coming from the various elementary radar units in order to form one or more global beams representing the total signal received by the radar in a given direction. Subsequently, the recombined data forming each global beam are processed separately by conventional processing methods for radar signals.

It should be noted that, depending on the functional configuration chosen, the distribution of the digital processing tasks for the received signals between the local processing modules 414 and the global processing module 43 may vary from one configuration to another in such a manner as to optimize the overall processing load and, consequently, the processing time and the number of computing units used.

According to the invention, the architecture of this third type 43 of sub-assembly is defined such that the overall processing capacity of the sub-assembly (building block) may be modified simply by adding or removing one or more processing nodes without having to do anything to the interfaces between the various sub-assemblies (building blocks). For this purpose, the implementation of the various computers is such that an operation contributing to a more general processing operation may be performed by one or other of the machines depending on the exact composition of the sub-assembly 43, so that the execution of a function can thus advantageously be distributed over all of the machines present in the sub-assembly for a given configuration. According to the invention, the digital data 431 coming from or going to the other sub-assemblies are carried via a dedicated communications bus.

FIG. 5 will next be considered.

The three types of sub-assemblies constituting the architecture according to the invention, by themselves, advantageously allow radar structures to be formed that correspond to different operational needs and having for this purpose given functional characteristics, in terms of angular precision and range, for example. For this purpose, as illustrated schematically by FIG. 5, the desired number of elementary radar structures (mini-radars) 41 should be associated by notably assembling the radiating faces with one another by arranging them on a mechanical supporting structure 51 so as to form a global antenna having the desired geometry. A single sub-assembly 43 should also generally be added that is designed to carry out the global processing of the signals supplied by the elementary radar structures 41, together with a single sub-assembly 42 designed to provide the general synchronization signals.

The general overall operation of course requires the architecture according to the invention to be supported by a set of digital data links symbolized by the set of solid arrows 52 and a set of synchronization links symbolized by the set of dashed arrows 53. These two sets form the exchange structure required for the synchronization of the operation of the various elementary radar units 41 and for the combined processing of the data supplied by these various units. This structure advantageously serves all the sub-assemblies in the same manner.

This exchange structure for digital data, for analog reference signals (local oscillators) and for synchronization signals can naturally be implemented in various ways, equally from the standpoint of the technical embodiment, from the standpoint of the hardware organization of the exchanges and from the standpoint of the exchange protocols implemented. The conditions required in its design are simply those associated with the need to conserve a highly upgradable character for the architecture according to the invention. In particular, the exchange structure must allow a variable number of elementary radar units to be integrated and the mode of operation of each of these units to be made fully adaptable, and allow the necessary information for making use of the data supplied by each of the elementary radar units 41 to be provided to the module 42, taking into account the way in which each of the units is configured. One example of such an exchange structure, principally formed by a star topology distribution of synchronous data and a communications system of the asynchronous “full duplex” point-to-point type, is notably described in the French patent application filed by the applicant and entitled “Architecture radar générique [Generic radar architecture]”, published on Dec. 15, 2006 under the reference FR2887096.

Thus, the radar architecture according to the invention, such as described in the preceding paragraphs, therefore takes the form of a modular architecture in which the characteristic elements that constitute the elementary radar units 41 operate with a high degree of autonomy with respect to one another, a fact which makes the overall operation of the architecture advantageously adaptable. Radar equipment designed according to this architecture is by nature upgradable, both in terms of the range of the functionalities implemented and of the overall performance levels attained. The operational performance of the equipment can readily be modified by adding or removing one or more elementary radar units 41 (typically, the number of units 41 can vary from 1 to a few hundred), and also by modifying the data processing routines implemented by the local processing devices 414 installed in these units, by modifying the parameters of the local waveform generator 415 or, alternatively, by modifying the data processing routines implemented in the global digital processing module 43. This architecture therefore provides a real solution to the problem which notably consists in designing upgradable multi-mission radar equipment that can, starting from a given configuration, be upgraded in a simple fashion to various different configurations, depending on new operational requirements.

FIGS. 6 and 7 will now be considered, which illustrate a first exemplary application of the modular radar architecture according to the invention.

One important advantage of the radar architecture according to the invention consists of the high modularity of the system. This modularity is advantageously applied in this first exemplary embodiment, in which the problem to be solved consists in finding the means of widening the transmission lobe of the radar.

Amongst all the functions implemented by multi-mission radar systems, two are always present:

surveillance, which forms the basic functionality of a radar system,

tracking a target of interest that was previously detected.

The known problem posed by the need to be able to fulfill these two categories of missions comes from the fact that their implementation by one and the same radar device leads to having to satisfy opposing requirements with regard to the beam width at transmission:

the performance as regards surveillance requires the formation of a wide transmission beam allowing simultaneous surveillance to be carried out over a group (or cluster) of received beams;

the performance as regards active tracking on detected targets requires the formation of a narrow transmission beam so as to focus the transmitted power onto the target being tracked.

Furthermore, it is known that even though, technically, it is relatively simple to widen a narrow beam with a given opening while it is technically difficult to contract a wide beam. In order not to suffer unnecessary signal losses, the transmission antenna has therefore to be of the same size as the receiving antenna.

In the prior art, the use of radar systems comprising an active antenna equipped with TR modules allows, in a known manner, a structure capable of forming narrow transmission beams aimed in a given direction to be obtained. On the other hand, as far as the widening of the transmitted beam is concerned, this widening is generally obtained, through lack of anything better, by modification of the phases applied by the microwave phase shifter to each transmission module. (Only the phase can be adjusted, not the amplitude, since, for reasons of phase stability and of thermal efficiency, transmitters operate in saturation mode). This way of proceeding has the advantage of being compatible with the hardware structure of current radar systems. On the other hand, it generates losses of around one to three decibels depending on the configurations.

Faced with such a situation of conflicting requirements, the use of a radar system whose structure conforms to the architecture according to the invention allows a simple and adapted solution to be provided. As FIG. 6 illustrates, the problem posed here can be advantageously solved by implementing a mode of operation in which the elementary radar units are configured in such a manner as to form an antenna 61 divided into several regions, two regions 61 and 62 in FIG. 6, each region forming a smaller transmission sub-antenna. With each sub-antenna is furthermore associated a specific central transmission frequency and a given passband. In the simple example in FIG. 6, the global antenna is divided into two sub-antennas, each sub-antenna being respectively associated with the central transmission frequencies fe₁ and fe₂.

In this exemplary embodiment, as FIG. 7 illustrates, the passbands B′ of the transmitted waves are substantially equal and have a value such that, in view of the values of the frequencies fe₁ and fe₂, and of the passbands B of the receivers of the elementary radar units, the waves transmitted by each of the two sub-antennas have non-overlapping passbands.

It is thus advantageously possible, without modifying the physical structure of the radar, to have two transmission sub-antennas, each with a size equal to half the size of the global antenna and hence producing a radiation pattern advantageously widened in bearing with respect to that of the global antenna. Moreover, since the signals emitted by the two sub-antennas have a frequency spectrum covered by the passband of the receivers, the entirety of the energy radiated in one direction of space and reflected by a target is received by the antenna so that the reception of the signal occurs without loss even though the beam has been widened at transmission. This concept can naturally be extended to the composition of more than two transmission antennas and over the two axes (azimuth and elevation).

In a more general manner, the important advantage obtained by the decomposition of the architecture according to the invention into a plurality of elementary radar units with high-level synchronization by a general synchronization module is particularly noticeable when the configuration sought requires the ability to drive each of the radiating sources separately. The preceding example shows only one use amongst others of this advantageous feature of the invention.

Following the same idea, it is notably possible to envision any type of application for which the capacity to drive each source separately represents an advantageous solution to the problem posed. Thus, in the same way as has been seen with the preceding example where the elementary radar units 41 composing one and the same antenna may be configured at transmission to form two wide-beam antennas, it is also advantageously possible to associate two radar systems designed following the architecture according to the invention in such a manner that the transmissions from each of the radar systems can be received by each of the antennas so as to, for example, obtain a gain in reception and hence to extend the range of the system.

Also along the same lines, one advantageous application of the architecture according to the invention consists in using this architecture to produce an active electronic scanning radar using a fixed antenna with four radiating panels, such as that illustrated by FIG. 8. Such an antenna allows, for example, a refresh time for the scanning to be obtained that is incompatible with a conventional rotating system (of the order of 0.1 s, instead of 1 s)

In this exemplary embodiment, the architecture according to the invention turns out to be particularly advantageous in that it allows an antenna to be obtained whose adjacent panels, 81 and 82 for example, emit microwaves with different frequencies Fe₁ and Fe₂, so that the reception by each of the two panels in question is not affected by the signal emitted by one of the adjacent faces and where only a single unit 42 is used for the four faces. Thus, as the figure illustrates, by configuring and by assembling the elementary radar units 41 composing the radar system in an appropriate manner, it is possible to obtain a radar system capable of being aimed in all the directions of space around it without the need for a rotating antenna. Accordingly, in the example in FIG. 8, the elementary radar units are divided into four panels 81 to 84 set back-to-back, in such a manner as to form an antenna in the shape of a parallelepiped, the panels 81 and 83, on the one hand, and 82 and 84, on the other, forming two groups of opposing panels (A and C on the one hand, B and D on the other) and the transmission frequency being the same (Fe₁ and Fe₂, respectively) for the two panels of the same group.

FIGS. 9 and 10 will now be considered. These illustrate a second exemplary application of the modular radar architecture according to the invention. This example illustrates how the architecture according to the invention advantageously allows a radar device capable of performing reconnaissance, identification and “NCTR” (Non-Cooperative Target Recognition) functions to be obtained in a simple fashion. The advantageous feature highlighted by this application consists of the possibility offered to define the waveform applied to each of the units 41 forming the radar antenna independently from one unit to the next.

The ability to perform the NCTR function assumes that the radar used is capable of transmitting and of receiving a microwave signal modulated over a very wide band. Thus, with the knowledge that the resolution is a direct function of the band of the transmitted signal, the idea of Very High Resolution or “WHR” is thus suggested. The excursion in frequency of the radar signal then reaches values of the order of 250 to 300 MHz (resolution of 0.50 m), to be compared with the operating modes with a conventional resolution of 1 to 10 MHz (15 to 150 m) or with the VHR mode of 50 MHz (3 m) for raid analysis.

In this type of mode of operation, the conventional “narrow-band” approximation no longer works whenever the antenna exceeds a size substantially greater than one meter. There is therefore a need to compensate for the propagation delays in the antenna. These delays are mainly a function of the position of the sensor in question and of the misaligning of the antenna beam formed. Thus, for example, for an antenna of 5 meters in diameter, the recovery on the periphery with respect to the center of the antenna may reach a maximum value of +/−5 ns.

In a conventional radar structure, this compensation is not easy and often a specific compensation for each source forming the antenna is impossible by design. In contrast, for a radar device built on an architecture according to the invention, this correction operation can be advantageously easily implemented both at reception and at transmission.

As far as the compensation for the delays affecting the received microwaves is concerned, the radar architecture according to the invention provides a receiver and a digitization device on each receiving channel of each elementary radar unit, so that the compensation can advantageously be carried out in the form of a simple digital correction operation on the signal received on each channel. The correction can thus be applied digitally in a simple and precise manner.

Regarding the transmitted microwaves, the manner of proceeding illustrated by FIGS. 9 and 10 may advantageously be implemented.

According to the invention, the transmitted pulsed microwave is synthesized by modulating the local oscillator OL₁, provided by the general synchronization module 42, with a signal FI formed by a local oscillator OL₂ at an intermediate frequency, itself modulated in frequency with a linear frequency ramp R, having a frequency excursion varying between −Δf and +Δf over an interval of time equal to Δt. Thus, for example, a frequency ramp extending over a range of 300 MHz (−150 MHz to +150 MHz) is applied for an interval of time equal to 30 μs corresponding to the duration of the transmitted pulse.

In nominal operating mode, the synthesis of the signal R is carried out in the same way for all the elementary radar units 41, in such a manner that the frequency of the of modulation ramp R is equal to zero in the middle of the duration of the transmitted pulse conforming to the curve 101 in FIG. 10.

In contrast, in a WHR mode of operation, the synthesis of the signal R is carried out in a different way for each unit 41, in such a manner that, for certain units 41, the passage of the signal R through a zero frequency occurs at a time before or after the time t₀ corresponding to the middle of the transmitted RF pulse. For this purpose, the excursion in frequency of the signal R is not centered on a zero frequency but shifted by a positive or negative frequency shift of, according to the curve 102 in FIG. 10. For the transmitted microwave, this frequency shift δf results in the corresponding time shift δt, this time shift being measured with respect to a general transmission synchronization signal sent in an identical manner to all the units 41.

Thus, for a given time T₀, referenced with respect to the general synchronization signal, the microwave pulses transmitted by a given elementary radar unit may appear on time, early or else late. Accordingly, the architecture according to the invention therefore advantageously allows a delay, variable at transmission between −5 ns and +5 ns in the example in FIG. 9, to be generated separately for each radiating element, which delay allows the variations in propagation time appearing between the various radiating sources to be compensated depending on their positions on the antenna.

The problems associated with the implementation of the WHR function are therefore accordingly naturally solved by the use of the architecture according to the invention.

Aside from the two types of application previously described, which are of course non-limiting within the scope claimed for the invention, further applications may be mentioned coming within the field of multi-beam radar, based on digital beam formation (DBF) for example, for which the possibility, offered by the architecture according to the invention for configuring each radiating element separately from the others, allows equipment with very advantageous performance characteristics with regard to anti-jamming capabilities to be obtained. It is thus possible to compose groups of radiating sources in order to form beams aimed in various directions and to carry out the anti-jamming of a beam formed by means of the signal received by the other beams. This possibility is furthermore reinforced by the fact that the processing of the signals received by the various channels can be carried out in a distributed manner by the local digital processing modules 414 and the global processing module 43, this distribution being itself adaptable.

In the same multi-beam context, albeit more modestly, the architecture according to the invention also enables the implementation of functions for refining angular measurements of the monopulse ecartometry type.

1. A modular radar architecture comprising a plurality of identical elementary radar units connected in parallel, each unit itself comprising:
a standard radiating surface comprising N radiating elements, capable of emitting and of picking up microwave radiation,
microwave emission and detection means for generating and transmitting to the radiating elements a microwave signal of a given form and power and also of amplifying the microwaves picked up by the radiating elements,
receiver means for performing the transposition into video band of the microwaves picked up and the digitization of the video signals obtained,
digital processing means for carrying out the conditioning of the digital signals supplied by the receiver means;
microwave signal generation means associated with a digitally-controlled waveform generator;
the microwave generation means, transmission means and receiver means each being composed of N independent devices arranged for forming, with the N radiating elements, N independent channels, the processing means and the synchronization means being common to all of the channels.

2. An architecture as claimed in claim 1, further comprising:
a sub-assembly responsible for the general synchronization of the structure, supplying to each sub-assembly a set of identical reference signals,
a global digital processing sub-assembly responsible for carrying out the processing of the conditioned signals supplied by each of the elementary radar units,
the various sub-assemblies being connected together by an appropriate data and signal exchange structure.

3. The application of the architecture as claimed in claim 1 to the production of a wide-beam radar system, wherein the N elementary radar units are configured such that N/2 radar units forming one half of the overall antenna emit over a frequency band B₁ around a frequency fe₁ and such that the N/2 radar units forming the other half emit over a frequency band B₂ around a frequency feₑ, the N elementary radar units being configured for covering, when receiving, a frequency band covering B₁ and B₂.

4. The application of the architecture as claimed in claim 1 to the production of a fixed antenna radar system, wherein the N elementary radar units being disposed over four panels set back-to-back in such a manner as to form an antenna in the shape of a parallelepiped, these elementary radar units are configured in such a manner that the units situated on one panel transmit and receive over a band of frequencies different from those over which the sources situated on the adjacent panels transmit.

5. The application of the architecture as claimed in claim 1 to the production of a radar system capable of performing functions of the NCTR type, wherein each of the N elementary radar units is configured in such a manner as to compensate for the propagation delays in the antenna, the compensation being achieved by a relative shift δf of the frequency excursion range Δf of the signal modulating in a linear fashion the transmitted microwave signal, this shift being a function of the position of the elementary radar unit in the antenna and of the depointing of the overall beam formed.
